(19) United States
(12) Patent Application Publication
(10) Pub. No.: US 2010/0108156 A1
(43) Pub. Date: May 6, 2010

(54) FLUID FLOW VALVE

(75) Inventor: Youval Katzman, Zichron Yaacov (IL)

Correspondence Address: THE NATH LAW GROUP, 112 South West Street, Alexandria, VA, 22314, US

(73) Assignee: A.R.I. FLOW CONTROL ACCESSORIES LTD., D.N. Ramat Hagolan (IL)

(21) Appl. No.: 12/452,576

(22) PCT Filed: Jun. 26, 2008
(86) PCT No.: PCT/IL2008/000878

§ 371 Date: Jan. 8, 2010

Related U.S. Application Data
(60) Provisional application No. 60/929,670, filed on Jul. 9, 2007.

(51) Int. Cl. F16K 24/04

(52) U.S. Cl. 137/202

(57) ABSTRACT

Disclosed is a gas purge valve that includes a housing formed with a fluid inlet and a fluid outlet. The fluid outlet is bounded by a kinetic valve seating, and a sealing assembly, which includes a float member coaxially displaceable within the housing, and a sealing cap coupled to said float member. The sealing cap is axially displaceable with respect to the float member between a first position in which it conjoins the float, and a second position in which it departs from the float. The sealing cap is formed at an outside face thereof with a kinetic seal fitted for sealing engagement of the kinetic valve seating, and an automatic valve aperture formed in the sealing cap and bounded by an automatic valve seating. An automatic sealing member articulated is at an upper end of the float member for sealing engagement of the automatic valve seating.

This is a National Phase Application filed under 35 U.S.C. 371 as a national stage of PCT/IL2008/000878, filed Jun. 26, 2008, an application claiming the benefit under 35 USC 119(e) U.S. Provisional Application No. 60/929,670, filed Jul. 9, 2007, the content of each of which hereby incorporated by reference in its entirety.

### FIELD OF THE INVENTION

This invention relates to fluid flow valves of the type adapted on the one hand to allow discharge of trapped gas at relatively small or large quantities, and on the other hand allow ingress of air so as to provide vacuum relief when the line is drained.

### BACKGROUND OF THE INVENTION

Such air purge valves are generally fitted to liquid conduits such as, for example, water mains distribution lines or other liquid supply lines, and are designed to ensure the release of air or other gases from the conduits, thereby avoiding the production of air locks, for example, which would interfere with the flow of the liquid.

For this purpose, two different kinds of air purge valves are known. In both kinds, a float is located in a housing which is coupled at a lower end thereof to the conduit to be vented and which is provided at its upper end with a venting aperture. In the course of normal operation with the flow of liquid through the conduit, the housing fills with liquid and the spherical float is forced upwardly against the outlet aperture sealing the same. When, however, air accumulates in the conduit, the float is displaced downwardly under its own weight thereby opening the outlet aperture with consequent venting of the air.

In a first kind of air purge valve, often referred to as the ‘automatic valve’, the outlet aperture is of relatively small dimensions and the float is displaced downwardly as soon as any air appears in the housing, thereby allowing for the continuous, automatic venting of the conduit. However, in view of the relatively small dimensions of the aperture, this automatic type cannot cope with situations wherein large quantities of air have to be vented and where such a situation arises, not all the air is released and some of it passes into the line, causing a build-up of air pressure and ultimately the creation of an air lock.

In order to cope with the situation wherein sudden large quantities of air appear in the line and have to be released, the so-called ‘kinetic valve’ is used. This valve has a relatively large aperture through which large quantities of air can be rapidly and effectively vented. However, with such kinetic valves, once the housing thereof has filled with liquid and the float has been pressed against the large aperture so as to seal it, the valve will only reopen once the pressure in the housing has dropped to atmospheric pressure and, in consequence, the kinetic valve cannot be used for the continuous release of small amounts of air.

In view of these limitations on the respective use of the automatic and kinetic valves, so called ‘combined valves’ have been designed which effectively consist of a kinetic valve and, superimposed thereon, an automatic valve. With such combined valves, continuous release of relatively small amounts of air throughout operation take place through the automatic valve, whilst sudden bursts of large quantities of air are released through the kinetic valve.

U.S. Pat. No. 4,770,201 discloses in its abstract a fluid flow valve such as a faucet or air-purge valve comprising a housing having defined therein a fluid through-flow aperture with a valve seating formed in the housing and bounding said aperture. A flexible closure membrane is secured at one end to the housing and is adapted to be biased, under fluid pressure in the housing, against the valve seating so as to seal the aperture. Membrane displacing means are secured to an opposite end of the membrane so that displacement of the displacing means in a first sense progessively detaches successive transverse portions of the membrane from the seating so as to open the aperture while displacement of the displacing means in an opposite sense allows for the membrane to become sealingly biased against the seating.

U.S. Pat. No. 6,145,533 discloses in its abstract an air release valve comprising a housing having a fluid inlet and a fluid outlet, a valve plate within the housing between the inlet and outlet, the valve plate having a pair of apertures; a valve seal assembly including a seal engageable with the valve plate overlying the apertures; a float located in the housing upstream of the valve plate and connected to the seal, the float displaceable between first and second positions in the housing such that displacement of the float in one direction opens the apertures, the float having a tapered end remote from the seal, the tapered end having a truncated substantially flat bottom surface and a groove extending across the flat bottom surface.

U.S. Pat. No. 7,011,105 discloses in its abstract a valve with a housing connectable to the pipeline or vessel. The housing has a first outlet venting to atmosphere and a control chamber which is exposed to internal pressure in the housing via a control chamber inlet. A first valve closure can move to open and close the first outlet. This valve closure is exposed to control chamber pressure tending to move it to close the first outlet and to internal housing pressure tending to move it to open the first outlet. When the housing is pressurized the first valve closure is maintained in a closed position by virtue of an unbalanced pressure force acting on it that is attributable to exposure of the valve closure to atmosphere through the first outlet. There is also a control chamber outlet from the control chamber to atmosphere. This outlet is larger than the control chamber inlet. The valve also incorporates a float in the housing which is arranged to be buoyed up by liquid entering the housing from the pipeline and a second valve closure carried by the float which is arranged to open and close the control chamber outlet in response to movement of the float caused by variations in the level of liquid in the housing. Downward movement of the float in response to a drop in liquid level in the housing, attributable to accumulation of air in the housing, causes the second valve closure to open the control chamber outlet. This allows the control chamber to vent to atmosphere. The pressure in the control chamber drops relative to the internal housing pressure and creates an unbalanced pressure force on the valve closure which causes it to open the outlet. The housing can then vent to atmosphere via the outlet:

It is an object of the present invention to provide an alternate flow-control valve of the combined type, with some improved features.

### SUMMARY OF THE INVENTION

The present invention offers a cheep yet reliable valve which combines a kinetic stage valve for facilitating fluid flow at substantially high rate, and an automatic stage valve for substantially low flow rate. The device according to the present invention has the advantages of a large devise yet it is more compact in size and cheep in manufacture.

According to the present invention there is provided a gas purge valve comprising a housing formed with a fluid inlet and a fluid outlet, said fluid outlet bounded by a kinetic valve seating, and a sealing assembly comprising a float member coaxially displaceable within the housing, and a sealing cap coupled to said float member; the sealing cap being axially displaceable with respect to the float member between a first position in which it conjoins the float, and a second position in which it departs from the float; said sealing cap formed at an outside face thereof with a kinetic seal fitted for sealing engagement of the kinetic valve seating, and an automatic valve aperture formed in the sealing cap and bounded by an automatic valve seating; and an automatic sealing member articulated to the float member for sealing engagement of the automatic valve seating.

The valve according to the present invention has one or more of the following featuring characters:
Alternatively, or in combination, the seal for the sealing cap may be fitted in the valve body.
The float member and the sealing cap articulated thereto, at the first position at least, form together an aerodynamic capsule-like shape;
The gas purge valve and its components are substantially symmetrical about a longitudinal axis thereof;
The sealing cap, at its second position, forms a space extending between a top surface of the float and a bottom surface of the sealing cap. By a particular embodiment this space is sealed at the said second position;
At high flow rates within the valve there is formed a low-pressure zone resulting in attachment forces acting between the float and the sealing cap so as to retain them at their articulated position;
The automatic sealing portion of the sealing assembly is axially displaceable within the housing and the configuration is such that it is axially displaceable within the kinetic sealing portion which is axially displaceable within the housing;
The automatic sealing member is in the form of a flexible strip articulated to the float member at least at one end thereof;
According to a particular design the automatic sealing member is in the form of a strip of resilient material secured to the top portion of the float at an inverted U-like shape, wherein at the second position thereof the resilient strip is axially deformed into sealing engagement with the automatic valve seating, to thereby seal the automatic valve aperture;
By modifications of the invention, the seal is connected at one end to the float and at the other end to the sealing cap, or the two ends of the seal are coupled to the float, or only one end is coupled to the float and the other end is loose;
There is provided a support member under the inverted U-like shaped sealing strip to prevent its buckling upon deformation and also to assist in sealing at low pressure;
One of the automatic sealing member and the automatic valve aperture are offset with respect to a longitudinal axis of the housing, thus giving rise to a non-homogenous pealing pattern of the automatic sealing member;
According to some particular features of the valve, the housing is designed with one or more of the following features:
   The housing is made of a single element integrated with the kinetic valve seating;
   A coupling for fitting to a fluid line is integrated at the inlet of the housing. The coupling is for example an internal/external threading, bayonet coupling, a flange for coupling with a band, etc.;
   The sealing assembly may be inserted as a whole through the inlet port of the housing having an aperture corresponding with a nominal diameter of the devise, though it may be assembled within the housing too;
   The hosing is devoid of any static components apart for a flow regulator inserted intermediate the inlet port of the housing and the float member, said flow regulator supporting the float member at its lowermost position;
   The housing is a substantially straight body without any major undercutting, i.e. the interior diameter of the housing is uniform;
The simple configuration of the housing renders it feasible to be manufactured of molded plastic material;
According to some particular designs the following geometrical ratios exist:

D_{A}/Dₙ≧0.32
where D_{A} is the fluid outlet diameter (the ‘kinetic seating’ diameter) and Dₙ is the nominal diameter of the thread of a pipe coupled to the valve;

Dₒₙₜ≦Dₙ+28 mm
where Dₒᵤₜ is the maximal external diameter of the housing.

According to an embodiment of the invention, an outlet deflector is fitted over the fluid outlet of the housing. Typically said deflector is fitted with a protective screen against dirt, insects and vandalism. Said deflector may be integrated with the body.

According to a variation of the invention there a one-way stopper is fitted within the deflector, over the fluid outlet, to thereby restrict fluid flow in an outwards direction only, i.e. to prevent fluid ingress into the housing via said fluid outlet. Optionally the stopper is biased into sealing engagement of the fluid outlet and will displace into an open position upon fluid egress through the fluid outlet. Thus, the valve may serve for the following functions:
Allowing air ingress and prohibiting egress;
Allowing air ingress and only partial air egress;
Allowing air egress and prohibiting air ingress.

### BRIEF DESCRIPTION OF THE DRAWINGS

In order to understand the invention and to see how it may be carried out in practice, several embodiments will now be described, by way of non-limiting examples only, with reference to the accompanying drawings, in which:

FIG. 1 is a perspective general view of a valve according to an embodiment the present invention;

FIG. 2 is a perspective, longitudinally sectioned view of the valve of the present invention;

FIGS. 3A and 3B illustrate a sealing cap used in the valve according to the invention, at a top perspective view and a bottom perspective view, respectively;

FIG. 4 is a top perspective view of a float closure used in the valve according to the invention;

FIGS. 5A to 5C are longitudinal sections illustrating the valve according to the invention at a fully opened position, a fully closed position and at an automatic open position, respectively;

FIG. 6A is a perspective view of a valve according to an embodiment of the invention, fitted with a one way stopper;

FIG. 6b is a bottom perspective view of the stopper seen in FIG. 6A; and

FIGS. 7A and 7B are representations of modifications of the valve's housing coupling arrangements.

### DETAILED DESCRIPTION OF EXEMPLARY EMBODIMENTS

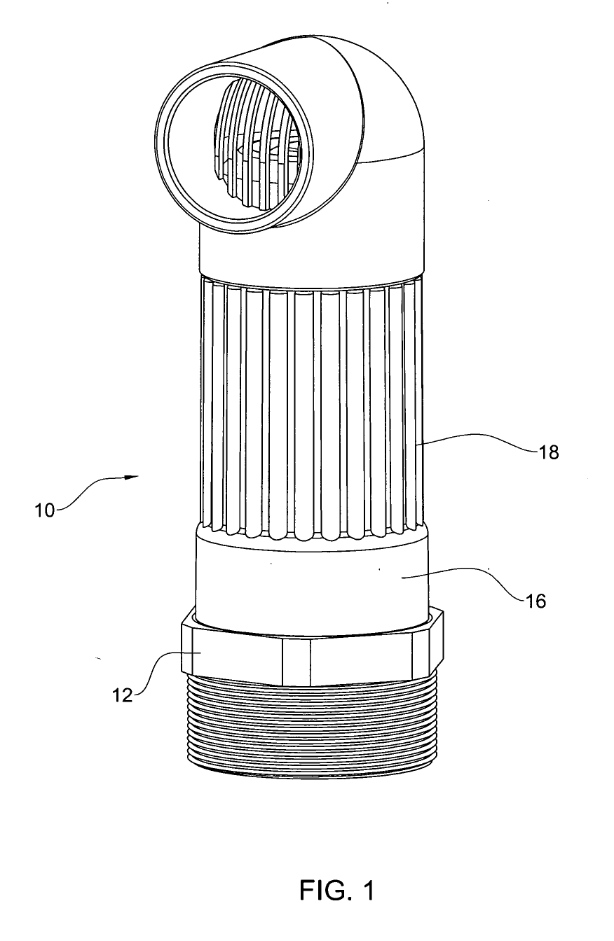

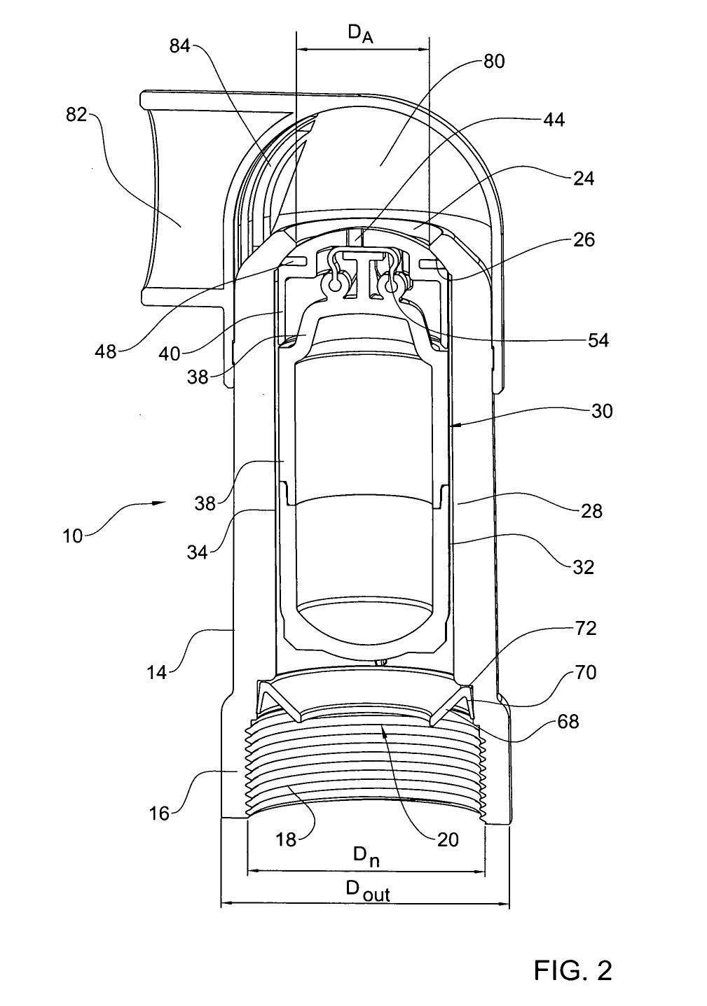

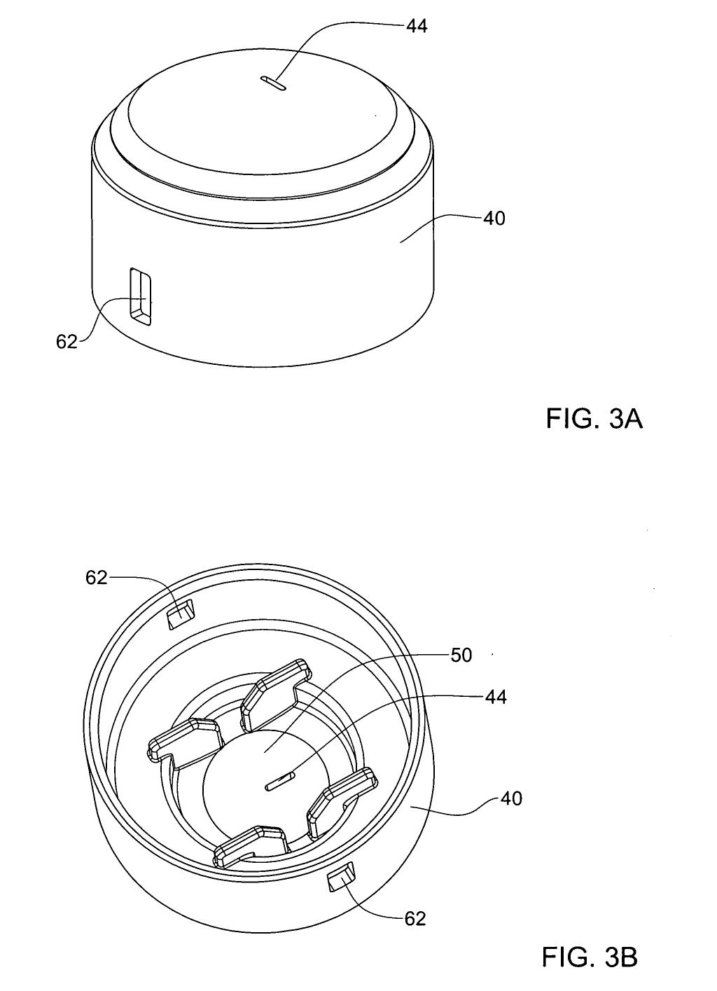

Attention is first directed to FIGS. 1 and 2 of the drawings illustrating a gas purge valve in accordance with the present invention and generally designated 10. It is noted that the valve in FIG. 1 is fitted with a threaded coupler 12, absent in FIG. 2, as will be discussed hereinafter in further detail.

The valve 10 comprises a generally cylindrical housing 14 formed with a coupling portion 16 which in the present embodiment is internally threaded at 18, and is formed with a fluid inlet 20 and a fluid outlet 24, the latter formed at a bottom face thereof with a kinetic valve seating 26.

Several axial ribs 28, radially extending are provided, two of which are seen in FIG. 2, and serve for the purpose of restricting displacement of a sealing assembly 30 to axial displacement within the housing and preventing rotation thereof.

The sealing assembly 30 comprises a float member 32 composed of a cylindrical bottom portion 34 sealed by a float closure member 38, together defining a sealed float member. The float is formed with axial recesses slidingly displaceable over the axial ribs 28.

The sealing assembly further comprises a sealing cap 40 articulated to the float closure 38, as will be explained hereinafter. The sealing cap 40 is formed with an automatic valve aperture in the form of slit 44 and a kinetic disk-like seal 48 for sealing engagement with the kinetic valve seating 26 at the fluid outlet 24 of the housing 14.

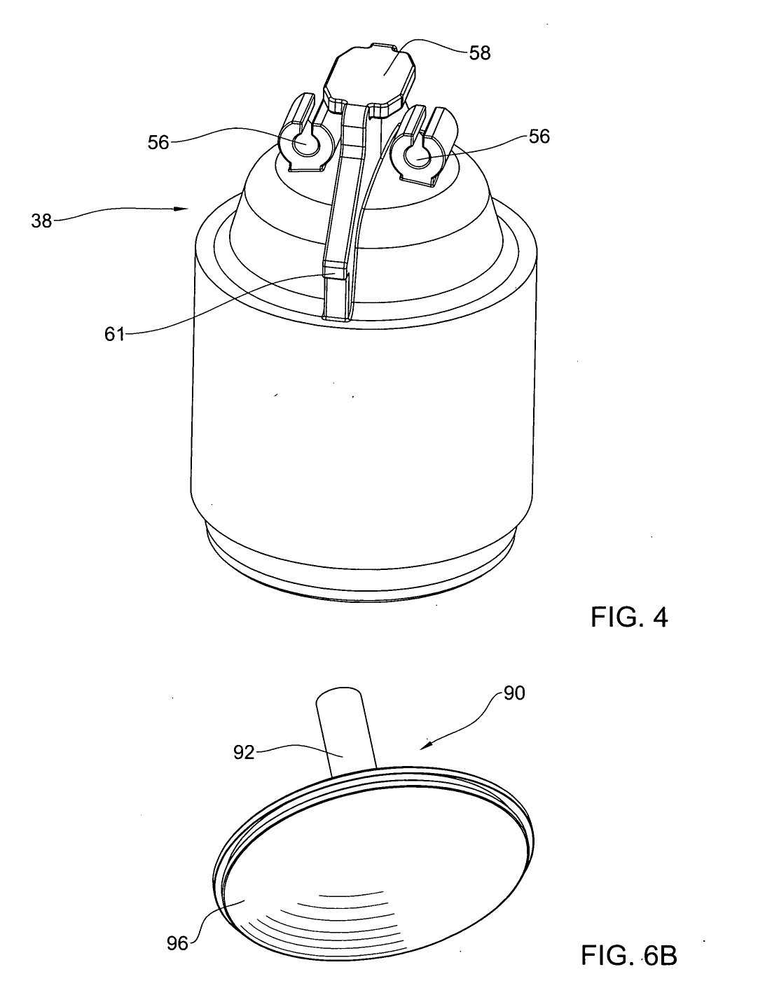

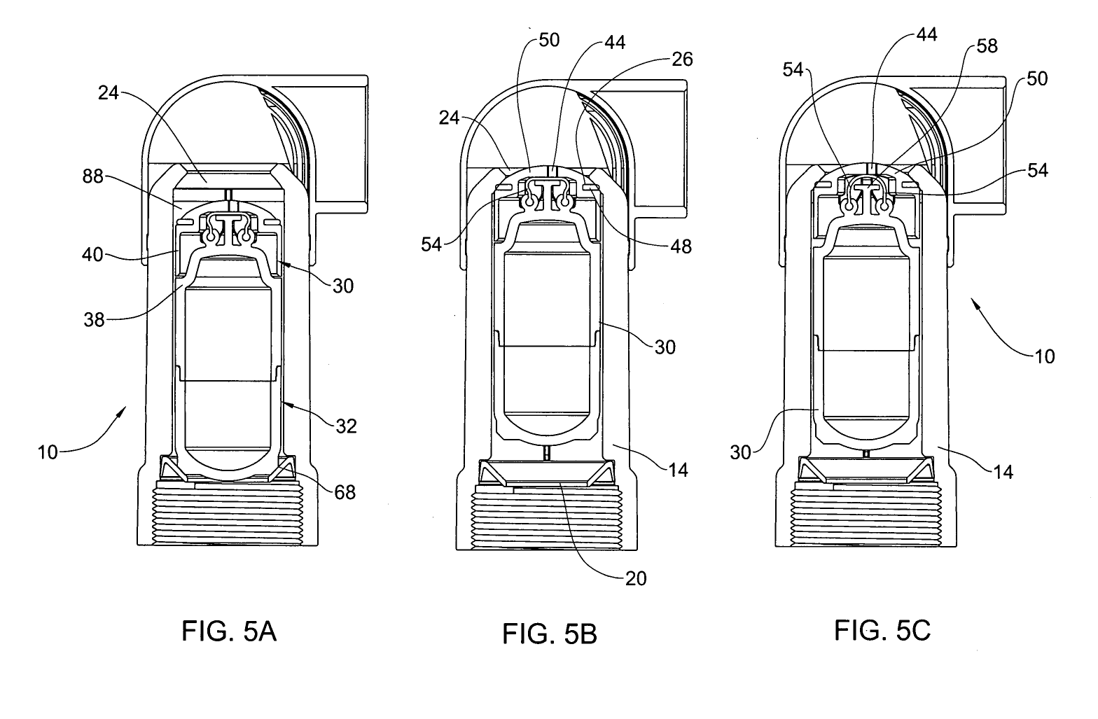

The automatic valve aperture 44 is bounded, at its bottom face with an automatic valve seating 50 sealingly engageable by an automatic sealing valve member 54, in the form of a strip-like resilient material, secured on the top portion of the float closure 38. In the embodiment as illustrated in FIG. 2 and as clearly illustrated in FIG. 4, the top closure 38 comprises two receptacle grips 56 for coupling said automatic sealing valve member 54 however retaining its flexibility. As can be seen in FIG. 5C, when the valve is at the so-called ‘automatic open position’ the automatic sealing valve member 54 is un-deformed and assumes a substantially U-like shape. However, upon sealing engagement with the automatic valve seating 50 (FIGS. 2, 5A and 5B) the automatic sealing valve member 54 is deformed to ensure full contact sealing of the automatic valve seating 50.

In order to ensure that the automatic sealing valve member 54 does not buckle at its deformed position, a support member 58 extends from the sealing cap 40, under the U-like shaped sealing strip, such that at the sealing position (FIGS. 2, 5A and 5B) it biases the resilient automatic sealing valve member 54 into sealing contact with the automatic valve seating 50.

It is further noted, that in FIG. 4, that the float closure 38 is formed with two lateral projections 61 (one of which is seen) radially projecting therefrom, for snap engagement within recessed aperture 62 formed in the sealing cap 40, thereby providing for some axial freedom of the sealing cap 40 with respect to the assembled float unit 32 however, ensuring that downward displacement of the float unit 32 entails retraction of the sealing cap 40 to thereby open the kinetic valve sealing as will be discussed in detail hereinafter.

The sealing cap 40 is axially displaceable with respect to the float member assembly 30 between a first position in which it conjoins the float assembly 32 and together assume an aerodynamic capsule-like shape (FIGS. 2, 5A and 5B) and a second position, in which the sealing cap 40 departs from the float closure 38, though remains articulated thereto as explained hereinafter in connection with lateral projection 62 and slidingly articulated within recesses 62.

As can further be noted, for example in FIG. 2, the assembled float and sealing assembly are supported within the housing by a flow regulator 68 which in turn is retained within the inlet 20 of the housing 14 by an annular shoulder 70 snappingly received within a corresponding shoulder 72 formed in the inlet of the housing. The flow regulator 68 serves also to support the float and to adjust air flow between the float bottom and the regulator, so as to give rise to a low pressure zone assist in maintaining the float at the open stage during kinetic air venting.

As can further be seen in the drawings, the valve 10 is fitted with an outlet deflector 80, snappingly mounted over the fluid outlet 24 of the housing. The deflector 80 is fitted with an outlet spout-like portion 82 to which a pipe extension may be fitted (not shown). A protective screen 84 is integrally fitted within the outlet reflector 80, against dirt, insects, and vandalism.

The structure of the valve 10 in accordance with the present invention as illustrated in the drawings, has several unique features. For example, the housing 14 is made of a single element integrated with a kinetic valve seating 26 and the design is such that the housing is a substantially straight body without any undercutting i.e. the interior diameter of the housing is substantially uniform, allowing for its simple manufacture e.g. by molding plastic material.

According to the design of the valve 10, the sealing assembly 30 is inserted into the housing 14 as a whole, through the inlet port 20 of the housing 14 having an aperture corresponding with a nominal diameter of the housing D.

According to some particular designs, the following geometrical ratios exist in the housing.

D_{A}/Dₙ≧0.32
where D_{A} is the fluid outlet diameter (the ‘kinetic seating’ diameter) and Dₙ is the nominal diameter of the thread of a pipe coupled to the valve;

Dₒᵤₜ≦Dₙ+28 mm
where Dₒₙₜ is the maximal external diameter of the housing.

As further noted in the drawings, the gas purge valve 10 and its components are substantially symmetrical about a longitudinal axis of the valve being the result of the simple structure of the device.

FIGS. 5A to 5C illustrate different operative positions of the valve. In FIG. 5A the valve 10 is in the so-called ‘fully opened position’, wherein the valve assembly 30 rests on the flow regulator 68 and wherein the sealing assembly 30 is at its so-called first position namely wherein the sealing cap 40 rests over the float closure 38, such that the kinetic valve fluid outlet 24 is entirely open, allowing for the discharge of substantially large amounts of gas therethrough. Gas flow is facilitated through a gap existing between the float assembly 32 and the inner walls of the housing 14. The capsule-like design of the float and sealing assembly are such that at high flow rates within the valve, there is formed a low pressure zone designated at 88 and resulting in attachment forces acting between the float assembly (namely the float closure 38) and the sealing cap 40 so as to retain them at their articulated, adjoining position.

FIG. 5B illustrates a position in which liquid flows into the housing 14 through the fluid inlet 20, resulting in buoyancy forces acting on the float assembly 32, urging the float and the articulated sealing assembly into tight sealing engagement of the kinetic fluid outlet 24 by means of kinetic seal 48 sealingly engaged with kinetic valve seating 26 and by sealing engagement of the automatic sealing valve member 54 with the automatic valve seating 50 of the automatic valve aperture 44.

The space extending between the sealing cap 40 and the float closure 38 is substantially closed and by an embodiment of the invention this space may be tightly sealed, e.g. by the provision of a sealing ring on either or both of the mating portions of the sealing cap and the float closure, respectively.

In FIG. 5C the valve 10 is illustrated in a position in which liquid level within the housing 14 decreases, allowing for descending of the float assembly 30 to thereby progressively detach the automatic sealing valve member 54 from the automatic valve seating 50 of the automatic valve aperture 44 whereby gas may now bleed through the automatic valve aperture 44 and facilitate in further detachment of the automatic sealing valve member into full disengagement resulting in further descending of the float assembly and entailing corresponding descending and disengagement of the sealing cap 40 so as to open the kinetic fluid outlet as in the position of FIG. 5A.

It is noted that the automatic sealing portion of the sealing assembly is in fact axially displaceable within the housing and a configuration is such that it is axially displaceable within the kinetic sealing portion which is in turn axially displaceable within the housing.

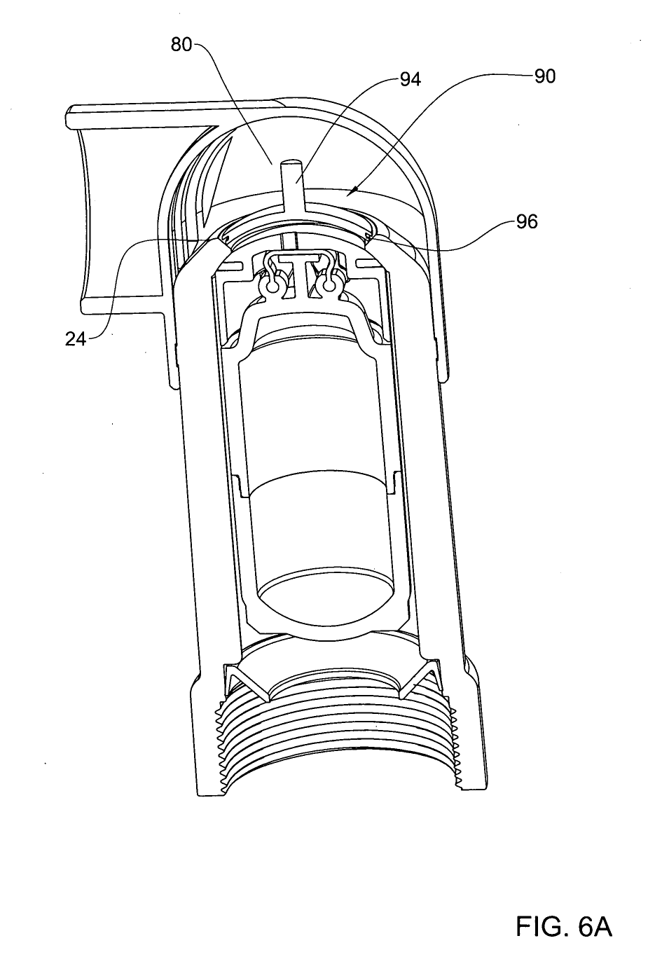

FIG. 6A illustrates a valve in accordance with a modification of the invention the difference being in the provision of a one-way stopper 90 formed with a stem portion 92 slidingly received within a receptacle 94 of the deflector 80 and comprises a sealing portion 96 fitted for sealing engagement with the automatic fluid outlet 24.

The arrangement is such that the stopper is a one-way valve normally biased downwards under its self-weight into sealing engagement of the outlet 24. However, owing to its light weight, it will displace upwardly (not shown) to disengage from the outlet 24 and facilitate free flow through the kinetic fluid outlet 24. According to a modification, there may be a biasing member the force of which being controllable so as to determine the opening force required for displacing the valve into its open position.

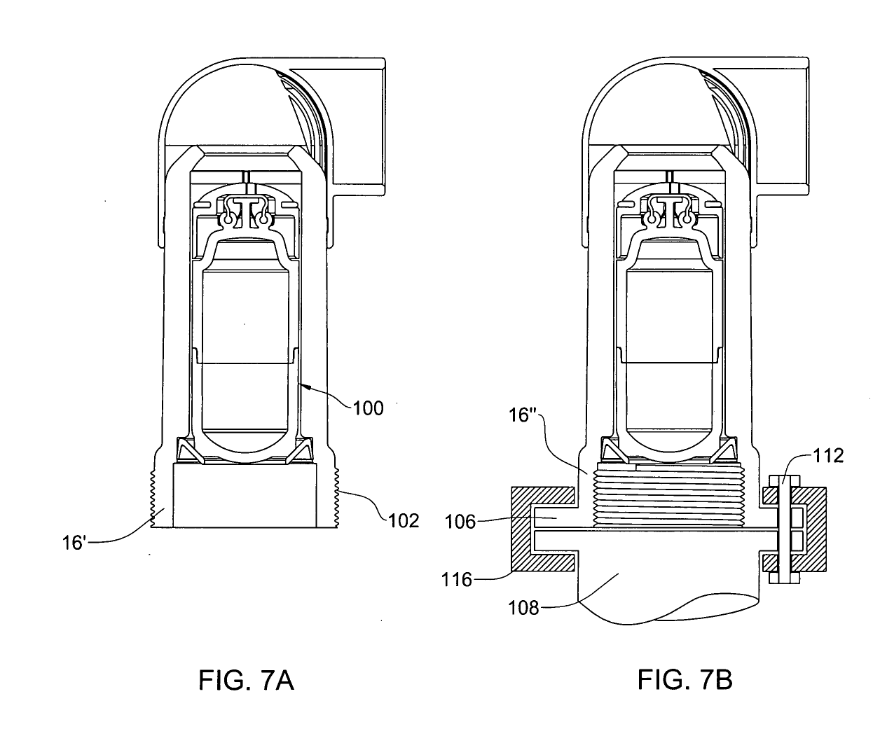

Turning now to FIG. 7A, there is illustrated an embodiment of the invention wherein the coupling portion 16′ of the housing portion 100 is fitted with an external threading 102 for coupling within a corresponding threaded pipe portion (not shown). In the embodiment of FIG. 7B, the coupling portion 16″ comprises a laterally extending flange 106 for coupling to a corresponding flanged tube member 108 by means of a bolt and knot 112 or by means of a brace member 116.

According to still an embodiment of the invention, one of the automatic sealing member and the automatic valve aperture are off-set with respect to a longitudinal axis of the housing, thus giving rise to the non-homogeneous pealing pattern of the sealing member.

While there has been shown a preferred embodiment of the invention, it is to be understood that many changes may be made therein without departing from the spirit of the invention.

1. A gas purge valve comprising
a housing formed with a fluid inlet and a fluid outlet, the fluid outlet bounded by a kinetic valve seating, and a sealing assembly comprising a float member coaxially displaceable within the housing, and a sealing cap coupled to the float member;
the sealing cap being axially displaceable with respect to the float member between a first position in which it conjoins the float, and a second position in which it departs from the float;
the sealing cap formed at an outside face thereof with a kinetic seal fitted for sealing engagement of the kinetic valve seating, and an automatic valve aperture formed in the sealing cap and bounded by an automatic valve seating; and
an automatic sealing member articulated at an upper end of the float member for sealing engagement of the automatic valve seating.

2. The gas purge valve according to claim 1, wherein the float member and the sealing cap articulated thereto, at the first position at least, form together an aerodynamic capsule-like shape.

3. The gas purge valve according to claim 1, wherein the gas purge valve and its components are substantially symmetrical about a longitudinal axis thereof.

4. The gas purge valve according to claim 1, wherein the sealing cap, at its second position, forms a space extending between a top surface of the float and a bottom surface of the sealing cap.

5. The gas purge valve according to claim 4, wherein the space is sealed at the said second position.

6. The gas purge valve according to claim 1, wherein at high flow rates within the valve there is formed a low-pressure zone resulting in attachment forces acting between the float and the sealing cap so as to retain them at their articulated position.

7. The gas purge valve according to claim 1, wherein the automatic sealing portion of the sealing assembly is axially displaceable within the housing and the configuration is such that it is axially displaceable within the kinetic sealing portion which is axially displaceable within the housing.

8. The gas purge valve according to claim 1, wherein the automatic sealing member is in the form of a flexible strip articulated to a top portion of the float member at least at one end thereof.

9. The gas purge valve according to claim 8, wherein the automatic sealing member is in the form of a strip of resilient material secured to the top portion of the float at an inverted U-like shape, wherein at the second position thereof the resilient strip is axially deformed into sealing engagement with the automatic valve seating, to thereby seal the automatic valve aperture.

10. The gas purge valve according to claim 9, wherein there is provided a support member under the inverted U-like shaped sealing strip, extending from the sealing cap, to prevent buckling of the sealing strip upon deformation.

11. The gas purge valve according to claim 1, wherein one of the automatic sealing member and the automatic valve aperture are offset with respect to a longitudinal axis of the housing, thus giving rise to a non-homogenous pealing pattern of the automatic sealing member.

12. The gas purge valve according to claim 1, wherein housing is made of a single element integrated with the kinetic valve seating.

13. The gas purge valve according to claim 1, wherein a coupling for fitting to a fluid line is integrated at the inlet of the housing.

14. The gas purge valve according to claim 1, wherein the sealing assembly is inserted as a whole through the inlet port of the housing having an aperture corresponding with a nominal diameter of a devise.

15. The gas purge valve according to claim 1, wherein the hosing is devoid of any static components apart for a flow regulator inserted intermediate the inlet port of the housing and the float member, the flow regulator supporting the float member at its lowermost position.

16. The gas purge valve according to claim 1, wherein the housing is a substantially straight body without any major undercutting, whereby the interior diameter of the housing is uniform.

17. The gas purge valve according to claim 1, wherein the housing is manufactured of molded plastic material.

18. The gas purge valve according to claim 1, wherein the following geometrical ratio exists:
D_{A}/Dₙ≧0.32
where D_{A} is the fluid outlet diameter and Dₙ is the nominal diameter of the thread of a pipe coupled to the valve.

19. The gas purge valve according to claim 1, wherein the following geometrical ratio exists:
Dₒᵤₜ≦Dₙ+28 mm
where Dₒᵤₜ is the maximal external diameter of the housing and Dₙ is the nominal diameter of the valve.

20.-21. (canceled)

22. The gas purge valve according to claim 20, wherein a one-way stopper is fitted within the deflector, over the fluid outlet, to thereby restrict fluid flow in an outwards direction only, to prevent fluid ingress into the housing via the fluid outlet.

23. (canceled)
